(19) United States
(12) Patent Application Publication
(10) Pub. No.: US 2008/0273467 A1
(43) Pub. Date: Nov. 6, 2008

(54) METHODS FOR DETERMINING PW CONNECTION STATE AND FOR NOTIFYING AC CONNECTION STATE AND THE ASSOCIATED EQUIPMENTS

(75) Inventors: Huachen ZHANG, Shenzhen (CN); Ting HUO, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/174,503

(22) Filed: Jul. 16, 2008

Related U.S. Application Data
(63) Continuation of application No. PCT/CN2006/002637, filed on Oct. 9, 2006.

(30) Foreign Application Priority Data
Jan. 17, 2006 (CN) 200610033144.2
Jan. 17, 2006 (CN) 200610033145.7

(51) Int. Cl. G06F 11/00

(52) U.S. Cl. 370/241.1

(57) ABSTRACT

Method for determining PW connection state and for notifying AC connection state and the associated equipments. For determination of PW connection state, PW-OAM packets are added to detect the PW connection state. A local PE transmits a PW-OAM request packet, and upon receipt of the PW-OAM request packet, a peer PE responds with a PW-OAM reply packet. If the reply packet is received within a preset time period, the local PE determines that the PW between the PEs is normal. For notification of AC connection state, an AC-OAM packet is added, the packet carrying fields for sub-AC identifications and sub-AC states. With the AC-OAM packet, the peer is notified of the sub-AC state change of the PE.

### CROSS-REFERENCE TO RELATED APPLICATIONS

This application is a continuation of International Patent Application No. PCT/CN2006/002637, filed Oct. 9, 2006, which claims priority to Chinese Patent Application Nos. 200610033145.7 and 200610033144.2, filed Jan. 17, 2006, all of which are hereby incorporated by reference in their entirety

### FIELD OF THE INVENTION

The invention relates to the technical field of Packet Switching Networks (PSN), and more particularly, to methods for determining Pseudo Wire (PW) connection state and for notifying Attachment Circuit (AC) connection state and the associated Provider Equipments (PE) in a PSN.

### BACKGROUND

Presently, operators provide various services in a parallel or overlapping manner, in which various networks have to be built and maintained, and for each of the various services, a different access device is used at a Point of Presence (POP). By doing so, the network plan becomes more complicated, and furthermore, both the constructional cost and the operational cost are rather expensive. When operators are providing various services, it is desirable to seek a method for providing various services over a public PSN so as to reduce the constructional and operational costs.

To provide a universal multi-service network platform, IETF had started the standardization work of “X over PSN” to carry any services over PSN, which is also named as Pseudo-Wire Emulation Edge-to-Edge (abbreviated as PWE3).

The emulated services over PSN may be classified into two types: 1 TO 1 mode in which one PW carries only one emulated service flow, and N TO 1 mode in which one PW carries multiple emulated service flows. When one PW carries multiple emulated service flows, one benefit is brought that the PW header may be utilized more effectively.

The establishment of a dynamic PW is the result of mutual negotiations between PEs at two sides, in which participation of Label Distribution Protocol (LDP) is necessary. PEs at both sides exchange their local PW forwarding states. The local PW forwarding state depends on the state of the AC (Attachment Circuit, or directly connected circuit) service to be emulated, the state of the LDP session with the remote PE and the state of the outer tunnel carrying the PW service. In the N TO 1 mode, the state of the AC service depends on the aggregation of the states of N sub-ACs corresponding to the PW (in the network model of the protocol, multiple PVCs bonded to one PW in the N TO 1 mode are collectively referred to as one AC. For ease of illustration, one PVC of the AC in the N TO 1 mode is referred to as one sub-AC of this AC). If all the sub-ACs corresponding to the PW become DOWN, the AC is in abnormal state or failure state. As long as one of the sub-ACs corresponding to the PW is UP, the state of the AC is UP.

In cases where the AC of the peer PE is DOWN, the AC forwarding table entry at the local PE needs to be removed. Otherwise, the AC service information of the local PE may not reach the final destination even if it reaches the peer PE, and valuable network bandwidth resources are thus wasted in vain.

Notification of the state may be performed in two modes: the Martini mode and the expanded Notification mode.

I. Martini Mode

When the AC state, the state of the LDP session with the remote PE and the state of the outer tunnel are all UP, the forwarding state of the local PW is Forwarding Allowed and a Mapping (label mapping) packet is sent. If any one of the three states is DOWN, the forwarding state of the local PW is Forwarding Not Allowed, and a Withdraw (label withdraw) packet is sent so as to withdraw the inner label, i.e., the PW label (a PW label may identify a PW when forwarding is performed). For example, when the PW is UP, the forwarding state of the local PW becomes Forwarding Not Allowed as long as the AC is DOWN, and a Withdraw packet is sent so as to release the protocol, as shown in FIG. 1.

II. Notification Mode

After the mapping packet for swapping inner layer labels is sent, the protocol is not released unless the configuration is removed, and only a Notification message is sent to exchange the local PW states of both parties. For example, in the case of PW UP, as long as the AC is DOWN, the forwarding state of the local PW is Forwarding Not Allowed. But at this time, no withdraw packet is sent to release the protocol, and a Notification packet is sent to notify the peer of the fact that the forwarding state of the local PW is Forwarding Not Allowed. In particular, this is implemented by notifying the forwarding code of the local PW, and the inner layer label is reserved. As shown in FIG. 2, the Notification packet contains the state code of the local PW.

In the related art, AC state notification is used to determine AC connection state, and the solution may be summarized as follows.

In the Martini mode, whether to send a mapping packet to swap the inner layer labels depends on whether the AC state, the state of the session with the peer PE and the state of the outer tunnel are all UP. If any one of the AC state, the state of the session with the peer PE and the state of the outer tunnel becomes DOWN, a Withdraw packet is sent to withdraw the inner layer label. After a configuration is performed in the Notification mode, as long as the state of the session with the peer PE is UP, the Mapping packet for swapping inner layer labels is sent, regardless of the AC state or the state of the outer layer tunnel. When the AC state or the state of the outer layer tunnel becomes DOWN, only the state code of the local PW is updated and the peer PE is notified of the state code of the local PW via a Notification packet. The main difference between the Notification mode and the Martini mode is: as long as the configuration is not removed, the protocol will not be released in the Notification mode to reclaim the inner layer label and only a Notification packet is sent to notify that the state of the local PW is in Forwarding Not Allowed. Accordingly, when the state becomes UP next time, there is no need to reassign a new label, and only a Notification packet is sent to notify that the state of the local PW becomes Forwarding Allowed.

The related art has limitations as follows:

(1) For a statically configured PW, that is, when the PW is established without participation of LDP protocols and is configured statically, it is impossible to notify the AC state of the peer and the state of the PW itself may not be known either because there is no participation of LDP protocols. Accordingly, the local PE may not know when the AC of the peer PE is DOWN or the PW itself is DOWN, and accordingly the associated AC forwarding table entry or the PW forwarding table entry at the local PE may not be removed. Valuable network bandwidth resources are thus wasted.

(2) For a dynamically configured PW, the Notification mode is advantageous over the Martini mode in that message and packet interactions between the PEs may be reduced. But they have a common shortcoming in that information about a specific AC service pair may not be notified.

As shown in FIG. 3, it is assumed that subAC1-subAC3 and subAC2-subAC4 are two service streams respectively and are multiplexed over PW1 in the N to 1 mode. SubAC1 and subAC2 are connected to different ports of PE1, and the combination of their states forms the AC state at PE1. SubAC3 and subAC4 are connected to different ports of PE2, and the combination of their states forms the AC state at PE2. At PE1, when the state of a LDP session with the remote PE is UP and the state of the outer tunnel is UP, if the state of subAC1 turns to UP from DOWN, the AC state at PE1 is UP. Then, the local PW forwarding state indicates that forwarding may be performed. A Mapping packet or a Notification packet is sent, to notify that the state of the local PW is UP now. At PE2, when both the state of a session with the peer PE and the state of the outer tunnel are UP, if the state of subAC4 changes to UP from DOWN, the AC state at PE2 becomes UP. Then, the local PW forwarding state at PE2 indicates that forwarding may be performed. Because the PW forwarding states for the local and peer PEs are both Forwarding Allowed, the state of the PW is UP and is delivered to the logic forwarding table entry. But in fact, subAC1 and subAC3 forms a service pair. After the service information of subAC1 arrives at PE2 through PW1, the service packet of subAC1 still will be discarded by PE2 because the subAC3 state is DOWN. Thus, it can be seen that in this case, neither the Martini mode nor the Notification mode can be used to notify correct information about the service pair of the AC. The service information of subAC1 may not reach its final destination even it reaches PE2 through PW1, and thus valuable network bandwidth resources are wasted.

The OAM (Operation, Administration and Maintenance) function plays an important role in public networks, with which the network operations may be simplified, the network performance may be monitored and the network operation cost may be reduced. The OAM function is especially important in a network providing QOS guarantee. As a key technology for the next generation scalable networks, multiple protocol label switching (MPLS) supports QOS and various network services and requires the OAM function. All MPLS OAM packets provided in ITU-T-Y.1711 use a globally known reserved label value 14, referred to as OAM Alert Label, which is distinguished from ordinary MPLS user traffic packets.

The OAM fault detection function is based on periodical transmissions of Connectivity Verification (CV) packet or Fast Failure Detection (FFD) packet from the ingress to the egress of the LSP. At the ingress, an OAM packet is encapsulated into an MPLS packet, that is, the outer layer label of the packet is the outgoing label of LSP at the node, the inner layer label is valued at 14 (OAM Route alert label), and the remainder is the payload of the OAM packet. When the egress detects a fault, it will send a Backward Defect Indication (BDI) packet through the backward channel. In this way, the state of the current LSP may be known at both the ingress and egress nodes.

The OAM packet payload includes OAM function type, data of specific function type and an ordinary BIP 16 error detection mechanism. To increase the processing speed and support the minimum packet length of the current two layer technology such as Ethernet, the minimum payload length of all OAM packets has to be 44 bytes.

The MPLS OAM mechanism proposed in Y.1711 involves two types of packets for connectivity verification: CV and FFD packets. A CV packet is sent every second, and a FFD packet is sent every 50 ms by default, and may be set to one FFD packet every 10 ms, 20 ms, 100 ms, 200 ms or 500 ms. The MPLS OAM fault detection function is based on periodical transmissions of Connectivity Verification (CV) packet or Fast Failure Detection (FFD) packet from the ingress to the egress on the LSP.

A PW in the data plane may be regarded as including two opposite LSPs. Similar to MPLS LSP, a detection technique is also needed for the PW to detect the availability of the connection. However, the OAM fault detection provided in ITU-T Y.1711 is not suitable for PW state detection. In the data forwarding plane, MPLS LSP is unidirectional. Fault detection in the data plane may be achieved by the “ingress transmission and egress reception” detection method as described in Y.1711. That is, the ingress transmits an OAM detection packet periodically to the egress and the egress determines whether the detection packet is received within a defined time period. Such a detection method can only work well with connectivity detection of a unidirectional link, and is not suitable for PW which is a bidirectional link. With the current Y.1711 OAM detection method, detection can be achieved in only one direction on the data plane and PW detection is not possible.

Thus, it can be seen that notification of sub-AC state and detection of PW state is not possible in the related art.

### SUMMARY

The related art is disadvantageous in that in the N to 1 mode for emulating services over PSN, the OAM fault detection is not suitable for PW state detection and correct information about a pair of emulated services may not be obtained. In view of these problems, the invention provides a method for determining PW connection state and a method for notifying AC connection state and the associated provider equipments.

To solve the above problems, the solution according to the disclosure is as follows.

A method for determining PW connection state in a packet switching network includes:

providing PW OAM packets for detection of connection state of a PW;

transmitting a PW-OAM request packet and waiting to receive a PW-OAM reply packet responded from a peer PE at a local PE, and

determining, by the local PE, that the PW between the local PE and the peer PE is normal when the PW-OAM reply packet is received within a preset time period.

Here, PW OAM packets comprising the PW-OAM request packet and the PW-OAM reply packet are provided for detection of connection state of the PW.

The local PE transmits a PW-OAM packet constantly via the PW link and determines whether the PW fails by detecting whether the transmitted packet is returned within the preset time period.

The method may further include: setting a PW availability flag in a PW hardware forwarding table to constrain the forwarding of a data packet, the PW availability flag being controlled by the detection result, forwarding the data packet normally when the flag is set to indicate that the PW is available, and not forwarding the data packet when the flag indicates that the PW is unavailable.

Three layers of labels are contained in the PW-OAM packet, the outer layer being a Label Switched Path (LSP) label, the middle layer being a PW label, the inner layer being an OAM label. Once the peer PE receives the PW-OAM request packet, a POP operation is performed on the LSP label and a SWAP operation is performed on the PW label.

An OAM flag is added to an Incoming Label Map (ILM) table to indicate whether an associated PW is configured with OAM function.

Upon receipt of the OAM request packet, the peer PE replies with the OAM reply packet by:

performing a POP operation on the outer-layer LSP label, and looking up the ILM (Incoming Label Map) table with the PW label so as to check the OAM flag, determining whether the PW is configured with OAM function according to the OAM flag, processing all the forwarding normally if the PW is not configured with OAM function, determining the next layer of label if the PW is configured with OAM function;

if the next layer of label exists and is a stack-bottom label with a value equal to 14 to indicate that the captured packet is a PW-OAM packet, so as to obtain new LSP and PW labels, performing a SWAP operation on the PW-OAM packet, and reassembling a PW-OAM packet to be sent back to the local PE.

The peer PE performs the SWAP operation on the PW label by:

establishing a SWAP table entry for the inner-layer label and delivering the SWAP table entry to hardware; and

performing the SWAP operation with the table entry after capturing the PW OAM packet.

The method further includes providing an AC-OAM packet, the packet carrying fields for sub-AC identifications and sub-AC states; and

notifying the peer PE via the AC-OAM packet when the sub-AC state of the local PE change.

A PE for use with the above method in a packet switching network includes:

a transmitting module,

a receiving module, and

an OAM module coupled to the transmitting module and the receiving module, configured to operate the transmitting module to transmit a PW-OAM packet;

after a packet is received by the receiving module and delivered to the OAM module for processing, if the packet is a reply to the transmitted OAM packet and is received within a preset time period, the PW between the PEs is determined to be normal.

A PE for use with the above method in a packet switching network includes:

a transmitting module,

a receiving module, and

an OAM module coupled to the transmitting module; in which

a PW-OAM packet is received by the receiving module and delivered to the OAM module for processing, and

the OAM module is configured to operate the transmitting module to return the PW-OAM packet back to the transmitting side.

A method for notification of AC connection state in a packet switching network includes:

providing an AC-OAM packet, the packet carrying fields for sub-AC identifications and sub-AC states; and

when the sub-AC state of the local PE changes, the peer PE is notified via the AC-OAM packet.

The PE records a local sub-AC state and a peer sub-AC state, and when the PE determines that a sub-AC state recorded at the local PE changes, the sub-AC state recorded at the local PE is updated before the peer is notified.

The method further includes: forwarding services with the PW associated with the sub-AC when both the local sub-AC state and the peer sub-AC state recorded at the PE are normal, and not forwarding services when the local sub-AC state or the peer sub-AC state recorded at the PE is abnormal.

Determining the sub-AC state includes: determining the sub-AC state to be normal when both the local sub-AC state and the peer sub-AC state are normal, and determining the sub-AC state to be abnormal when the local sub-AC state or the peer sub-AC state is abnormal.

A mapping correspondence among sub-AC, PW and sub-AC state is established in the PE and set in the sub-AC hardware forwarding table;

the service forwarding includes: obtaining an associated sub-AC state with the sub-AC, forwarding with the associated PW when the sub-AC state is normal and not forwarding when the sub-AC state is abnormal.

The sub-AC is identified with a sub-AC identification;

the sub-AC identification is a VPI/VCI or a VLAN ID, or the sub-AC identification is a universal ID for a pair of services, and the mapping correspondence among the universal ID and the VPI/VCI or VLAN ID is set on the PE.

The process of updating the sub-AC state recorded at the local PE includes: providing a sub-AC state table in the PE, reflecting the sub-AC state by setting the local sub-AC state and the peer sub-AC state table entries in the sub-AC state table; modifying the local sub-AC state when the local sub-AC state changes; and modifying the peer sub-AC state according to the sub-AC state in a received AC-OAM packet.

A PE for use with the above method in a packet switching network includes an AC circuit module, a transmitting/receiving module, and an OAM module coupled to the AC circuit module and the transmitting/receiving module; the AC circuit module is configured to notify the OAM module of a sub-AC state change; and the OAM module is configured to operate the transmitting/receiving module to transmit an OAM packet carrying fields for sub-AC identifications and sub-AC states to notify the peer.

The PE further includes a sub-AC hardware forwarding table module coupled to the OAM module, where the mapping correspondence among sub-AC ID, state and PW is established in the sub-AC hardware forwarding table module, the sub-AC is in normal state when the sub-AC states at both sides are normal, the sub-AC is in abnormal state when the local sub-AC state or the peer sub-AC state is abnormal.

To forward services, the OAM module refers the sub-AC hardware forwarding table module for an associated sub-AC state, and when the sub-AC is in normal state, and the transmitting/receiving module performs service forwarding with the PW.

The PE further includes a sub-AC state table module coupled to the OAM module, configured to record the local sub-AC state and the peer sub-AC state, so as to reflect the availability of the sub-AC.

For the method of determining PW connection state and the associated PE, the invention is advantageous in that the OAM fault detection proposed in Y.1711 is extended in the invention so that the network performance monitor and fault alert mechanism with special OAM labels may be applicable to PW. Then, connectivity detection in the PW data plane may be performed effectively, and determination of the PW connectivity may be achieved.

The detection method in the present invention may be used for general purposes. During the whole detection process, the PW-OAM packet is processed without involving any specific services. The dedicated line or link emulated by the detected PW may be any one provided in IEEE PWE3 draft, such as Eth/TDM/FR/ATM.

For the method of notifying AC connection state and the associated PE, the invention is advantageous in that notification of AC state may be achieved by extending the OAM type defined in ITU-T-Y.1711. When the PW bonding fashion is ATM N to 1, once there is a sub-AC state change, the peer is notified by means of the OAM packet which may carry fields for identifying VPI/VCI (or VLAN ID) of the sub-AC. By doing so, the following defects of the related art may be solved: the PW state UP caused by AC UPs not belonging to a same pair of services may not correctly reflect the packet forwarding condition; as a result, even if the AC information for one side reaches the PE at the other side via a PW, the forwarding may not continue, and the AC information needs to be discarded by the PE; and the processing resources of the nodes along the way and the valuable network bandwidth resources are thus wasted.

In the present invention, AC-OAM packets are introduced to facilitate acquisition of precise information about the emulated service pair and reject the PW UP caused by sub-AC UPs not belonging to the same emulation service pair. In this way, the PW state is strictly consistent with the actual forwarding state, and the effectiveness of PW forwarding is improved. Service transmissions unable to find ultimate connectivity will no longer waste the processing resources of the nodes along the way and the valuable network bandwidth resources. Furthermore, the problem that static PW may not notify AC state, is solved.

### BRIEF DESCRIPTION OF THE DRAWINGS

FIG. 1 is a diagram illustrating the principle with which state notification is performed in the Martini mode;

FIG. 2 is a diagram illustrating the principle with which state notification is performed in the Notification mode;

FIG. 3 is a diagram illustrating the connection relationship that a PW carries multiple emulated service flows;

FIG. 4 is a diagram illustrating the PW detection principle according to an embodiment of the invention;

FIG. 5 is a diagram illustrating the PW-OAM detection process according to an embodiment of the invention;

FIG. 6 is a diagram illustrating the AC state notification principle according to an embodiment of the invention;

FIG. 7 is a flow chart illustrating the AC state notification transmission process according to an embodiment of the invention; and

FIG. 8 is a flow chart illustrating the AC state notification reception process according to an embodiment of the invention.

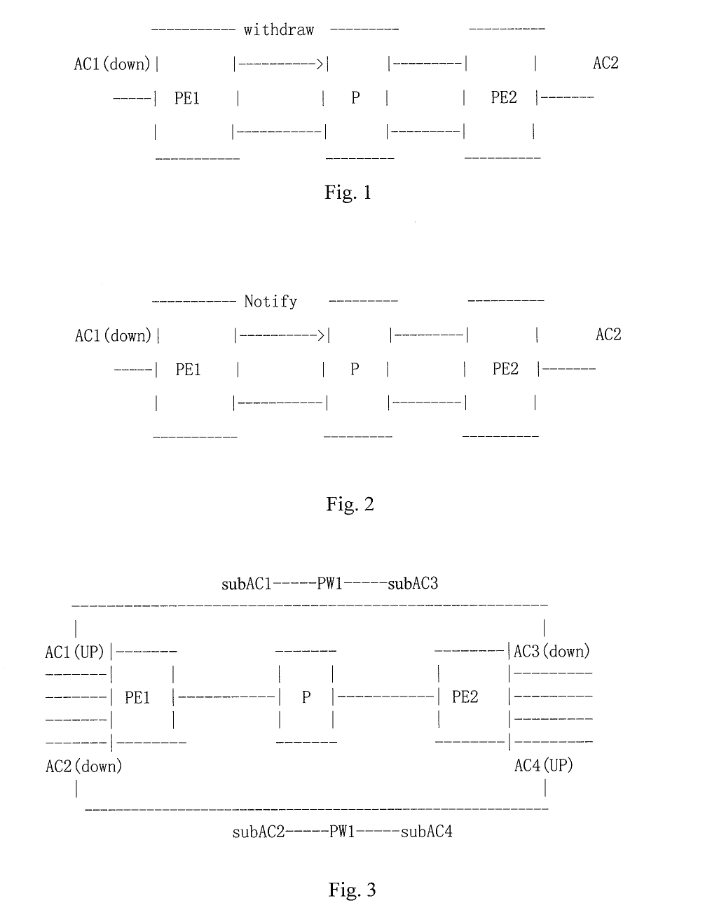

### DETAILED DESCRIPTION

Detailed descriptions will be made below to the invention with reference to specific embodiments and accompanying drawings.

First, descriptions will be made to the method for determining PW connection state and the associated PE.

At present, there are two ways for implementation of OAM function. In the first way, OAM labels are defined for network performance monitor and fault alert, which are similar to the OAM cells in ATM. In the second way, network faults are discovered and located by simulating ICMP (Internet Control Message Protocol) echo request and ICMP reply, which is similar to Ping in conventional IP networks. In the present invention, the above two OAM implementations are combined, that is, PW fault detection is performed by defining dedicated OAM labels and simulating ICMP echo request and ICMP reply.

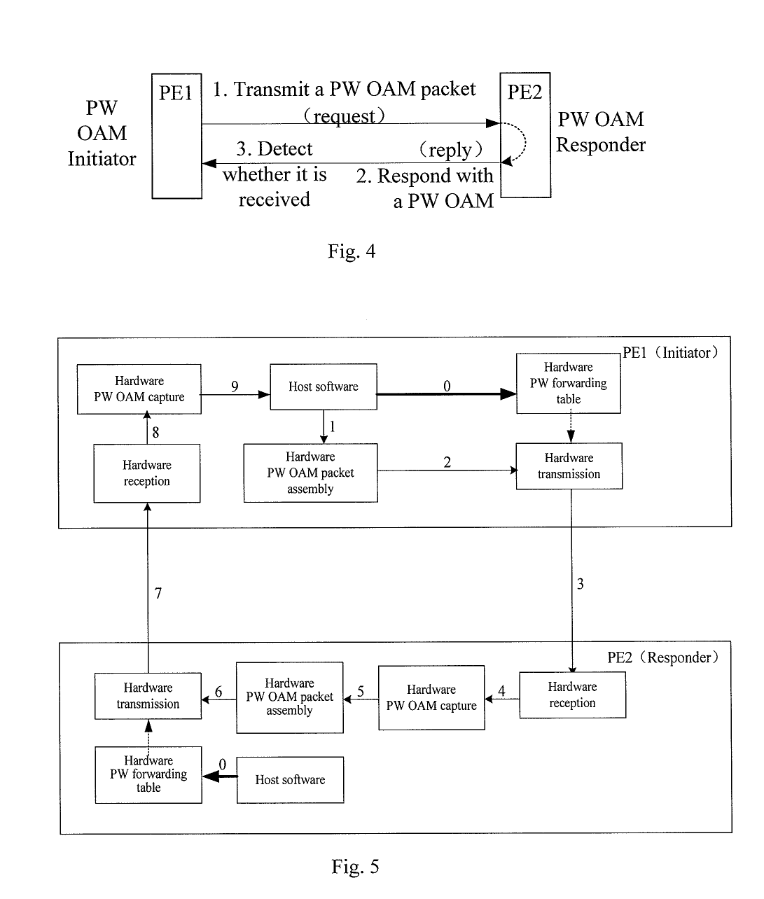

As shown in FIG. 4, PE1 is configured to transmit an OAM request packet and is thus referred to as PW-OAM initiator, and PE2 is configured to respond with an OAM reply packet upon receipt of the OAM request packet and is thus referred to as PW-OAM responder. With back and forth of the PW-OAM packets on the PW link to be detected, the PW is determined to be normal when PE1 receives the packet within a preset time period, and a fault alert is generated when PE1 fails to receive the packet within the preset time period. The steps involved are as follows.

1. The PW-OAM initiator sends a PW-OAM request packet.

2. Upon receipt of the PW-OAM request packet, the PW-OAM responder responds with a PW-OAM reply packet.

3. The PW-OAM initiator determines whether the PW-OAM reply packet is received within a preset time period. If the PW-OAM reply packet is received within the preset time period, the PW is determined to be normal. Otherwise, if no PW-OAM reply packet is received within a preset time period, a fault alert is generated.

As shown in FIG. 5, a PW-OAM detection process includes the following steps.

(0, the precondition) A PW is established between PE1 (the initiator) and PE2 (the responder). Forwarding table entries are generated by both host software, and delivered to the hardware (in this way, forwarding may be performed by directly accessing the hardware table entries without accessing the software). OAM function is configured at PE1 and PE2 respectively for detecting the established PW.

(1) PE1 starts an OAM detection timer and initiates OAM detection.

(2) PE1 host software delivers the OAM labels to the hardware and assembles an OAM packet.

(3) PE1 transmits the OAM packet according to the PW hardware forwarding table.

(4) PE2 receives and parses the OAM packet, and handles the OAM packet to the OAM hardware module for processing.

(5) PE2 OAM hardware module analyzes the packet, and handles OAM packet to the OAM packet assembly module for processing.

(6) PE2 assembles an OAM packet.

(7) PE2 sends the assembled OAM packet.

(8) PE1 receives and parses the assembled OAM packet, and handles OAM packet to the OAM hardware module for processing.

(9) The packet is delivered to the host software, and a detection is completed.

A specific description will be made below to the process at the PW-OAM initiator.

(I) Function

To detect the bidirectional PW connectivity on the data plane, the OAM packet has a round trip over the PW link. The OAM packet is sent from the initiator PE. After a round trip over the link, the OAM packet is received at the initiator PE. In this manner, the processes of the LSP OAM ingress and egress may be integrated into one PE device. The transmission is originated from the initiator and the detection is also made at the initiator. In other words, the LSP OAM transmission, reception and detection mechanisms are migrated and combined directly, to form the OAM function of the PW initiator.

(II) PW-OAM Packet

A novel OAM detection packet is defined for detection of PW connection state in the present invention, i.e., PW-OAM packet, which is similar to the CV and FFD packets in LSP OAM. The Function Type of the packet is 0x08. The format of the packet is shown in Table 1.

TABLE 1

| Function Type (0x08) | Reserved |
|---|---|
| 1 byte | 48 bytes |

The initiator transmits an OAM packet constantly over the PW link, and determines locally whether the transmitted packet is returned within a preset time period, so as to detect whether the PW fails.

(III) PW Availability Flag: PW_Avail_Flag

In the present invention, a new PW Availability Flag, i.e., PW_Avail_Flag, is defined in the existing PW hardware forwarding table (NHLFE), for constraining the forwarding of the PW date packet. The format of the PW hardware forwarding table is shown in FIG. 2.

TABLE 2

| NHLFE-id | PW Label | LSP Label | . . . | PW _Avail_Flag |
|---|---|---|---|---|
| | | | . . . | |
| | | | . . . | |

If PW_Avail_Flag is equal to 1, the PW is available and data may be forwarded normally. Otherwise, if PW_Avail_Flag is equal to 0, it indicates that the PW fails and the data packet needs to be discarded. The flag is controlled based on the detection result. When it is detected that the PW fails, the flag is set to 0 and the data is prevented from being forwarded. Conversely, when it is detected that the PW returns to be normal, the flag is set to 1 and the data may be forwarded normally.

It is to be noted that PW_Avail_Flag only constrains data packets except the OAM packet. For OAM packets, this flag is invalid. That is, the flag may not be used to control the forwarding of the OAM packets. OAM packets are also forwarded by looking up the table. If PW_Avail_Flag affects the forwarding of the OAM packets, this flag fails to be set to 1.

Detailed descriptions will be made below to the process at the PW-OAM responder.

(I) The Inverse Forwarding of the PW-OAM Packet

A PW-OAM packet includes three layers of labels. The outer layer is used for LSP forwarding, the middle layer is used for PW forwarding, and the inner layer is OAM label: 14. The format of the PW-OAM packet is shown in Table 3.

TABLE 3

| Link Layer | LSP Label | PW Label | OAM Label | PW-OAM Packet |
|---|---|---|---|---|
| | | | (14) | |

LSP OAM performs a POP operation on the LSP forwarding label at the peer, and label 14 is processed for POP operation by the OAM module, and the final detection is made at the host software. But PW-OAM is not detected here, and the OAM packet is sent back to the initiator. After the responder receives the OAM packet, a POP operation is still performed on the LSP label and a SWAP operation is performed on the PW label, so as to obtain new PW label and LSP label. Via the newly obtained labels, the OAM packet is sent back. This process is referred to as PW-OAM inverse forwarding here. With the detection method of the present invention, the detection procedure is similar to the Ping operation. The operations at the responder involve a process of parsing and assembling, including: receiving, parsing, assembling and transmitting.

(II) The PW-OAM Detection Flag: OAM_Flag

In a PW-OAM inverse forwarding process, all packets are processed by hardware, with no participation of any software, so as to achieve a high forwarding efficiency. In this way, after PW-OAM is configured, the responder has to establish a SWAP table entry for inner labels and delivers it to hardware, so that upon receipt of the OAM packet, the responder may send it back to the initiator.

To perform inverse forwarding, an OAM flag (or, OAM_Flag) is added to the hardware ILM (Incoming Label Map) according to the invention. OAM_Flag is also denoted as OAM_F, and it indicates whether the PW is configured with OAM. For example, if the PW is configured with OAM, OAM_F is set to 1; otherwise, it is set to 0. The structure of an ILM table supporting PW-OAM is shown in Table 4.

TABLE 4
ILM Table

| | | | | | |
|---|---|---|---|---|---|
| Label | OAM_F | 0 | | OP | P0P . . . |
| | | 1 | Next | | SWAP . . . |
| | | | Layer | | |
| | | | Label is | | |
| | | | not 14 | | |

| | |
|---|---|
| Next | SWAP NHLFE-id (The detected |
| Layer | PW) |
| Label is 14 | |

(III) The Inverse Forwarding Process

As described above, the PW-OAM inverse forwarding may be implemented as follows.

When the responder receives a PW packet, a POP operation is first performed on the outer LSP label and then the ILM table is looked up according to the PW label. After a hit is found, the OAM_F value is checked.

If OAM_F is equal to 0, it indicates that PW is not configured with OAM, and all the forwarding are processed normally.

If OAM_F is equal to 1, it indicates that PW is configured with OAM, and the next layer label is to be determined. If there exists the next layer label and it is at the bottom of the stack with a value of 14, it indicates that the captured packet is an OAM packet. A SWAP operation is performed on the OAM packet to obtain new LSP label and PW label. Then, an OAM packet is reassembled and sent back to the initiator.

The invention also provides a PE based on the above method of determining PW connection state in a packet switching network, such as PE1 shown in FIG. 5, including: a transmitting module, a receiving module and an OAM module (shown as the dotted block in PE1 in FIG. 5) coupled to the transmitting module and the receiving module. The OAM module is configured to operate the transmitting module to transmit a PW-OAM request packet. After a packet is received by the receiving module, the packet is delivered to the OAM module for processing. If the received packet is a reply to the transmitted OAM request packet that is received within a preset time period, the PW between the PEs is determined to be normal.

The invention also provides another PE based on the above method of determining PW connection state in a packet switching network, such as PE2 shown in FIG. 5, including a transmitting module, a receiving module, and an OAM module (shown as the dotted block in PE2 in FIG. 5) coupled to the transmitting module. A PW-OAM request packet is received by the receiving module and delivered to the OAM module for processing. The OAM module is configured to operate the transmitting module to return a PW-OAM reply packet to the transmitting side.

With the above methods and PEs, the connectivity detection of the PW data plane may be achieved effectively. In this case, if the PW state UP is caused by AC UPs not belonging to the same pair of services, the PW state may not reflect the actual forwarding condition. As a result, even if the AC information for one side reaches the PE at the other side via a PW, the forwarding may not continue, and the AC information needs to be discarded by the PE. In this manner, the processing resources of the nodes along the way and the valuable network bandwidth resources are wasted.

A description will be given below to the method and PE for notification of AC connection state.

The disclosure provides a method for notification of AC connection state in PSN, including the following contents.

I. AC-OAM Packet

According to the invention, the OAM type defined in ITU-T-Y.1711 is extended. AC-OAM packet is added to notify the peer when there is a change in the local AC state. The transmitted AC-OAM packet carries a VPI/VCI field for identifying a sub-AC. A byte indicates the state of a sub-AC, that is, the state of a PVC. The Function Type of the AC-OAM packet is 0x09. Other Reserved field is 0x00. The format is shown in Table 5.

TABLE 5

| Function | Reserved | Sub-AC | | |
|---|---|---|---|---|
| Type (0x09) | (all 0x00) | state code | VPI/VCI | Reserved |
| 1 byte | 2 bytes | 1 byte | 4 bytes | 48 bytes |

Instead of detecting the connectivity of a sub-AC, AC-OAM is to notify the peer of a change in the local sub-AC state by means of the OAM packet.

II. AC Hardware Forwarding Table

To control the effectiveness of forwarding the emulated data over the PW, an AC-PW bonding relationship is added to the hardware table existing at the PE, to emulate the effectiveness of data forwarding over the PW. This table is stored in hardware for forwarding control, and is referred to as AC hardware forwarding table in the invention. In the AC hardware forwarding table, VPI/VCI and PW Label are used to represent the AC-PW bonding relationship, and AC_Avail_Flag is defined. The format of the AC hardware forwarding table is shown in Table 6.

TABLE 6

| VPI/VCI | PW Label | . . . | AC _Avail_Flag |
|---|---|---|---|
| | | . . . | |
| | | . . . | |

When service forwarding is performed, the table is looked up first according to the VPI/VCI, to determine whether the PW having an AC is available, that is, whether service can be forwarded normally over the PW. For example, if AC_Avail_Flag is equal to 1, the PW is available and packets may be transmitted normally by referring to the PW hardware forwarding table existing in the PE according to the PW label. If AC_Avail Flag is equal to 0, the packet is discarded.

III. AC State Table

In each PE, an AC state table is added to the host software. The table includes two fields: the local AC state and the peer AC state, indicating the AC states of the local PE and the peer PE respectively. VPI/VCI in the AC state table functions as an index to identify a channel. The AC state table has a format shown in Table 7.

TABLE 7

| VPI/VCI | Local AC state | Peer AC state |
|---|---|---|
| . . . | . . . | . . . |
| . . . | . . . | . . . |

The local AC state is affected by the local AC module. When the local AC state changes, the AC module notifies the host software to change the local AC state in the AC state table. The peer AC state is affected by the AC-OAM packet. When an AC-OAM packet is received, the peer AC state in the AC state table is changed according to the sub-AC state in the packet.

The AC state table affects the AC hardware forwarding table. If both the local AC state and the peer AC state are UP, the host software sets AC_Avail_Flag in the AC hardware forwarding table to 1 so that the PW corresponding to the sub-AC is available. If the local AC state or the peer AC state is DOWN, the host software sets AC_Avail_Flag in the AC hardware forwarding table to 0 so that the PW corresponding to the sub-AC is unavailable and forwarding is not allowed.

IV. AC State Notification Process

1. AC State Notification Principle

An AC state notification process may be divided into a transmission process and a reception process. When the AC state of PE1 changes, PE1 modifies the related table entries of the local PE and then sends an AC-OAM packet to PE2 to notify the AC state. Upon receipt of the AC-OAM packet, PE2 parses the packet and modifies the associated table entry according to the content of the packet.

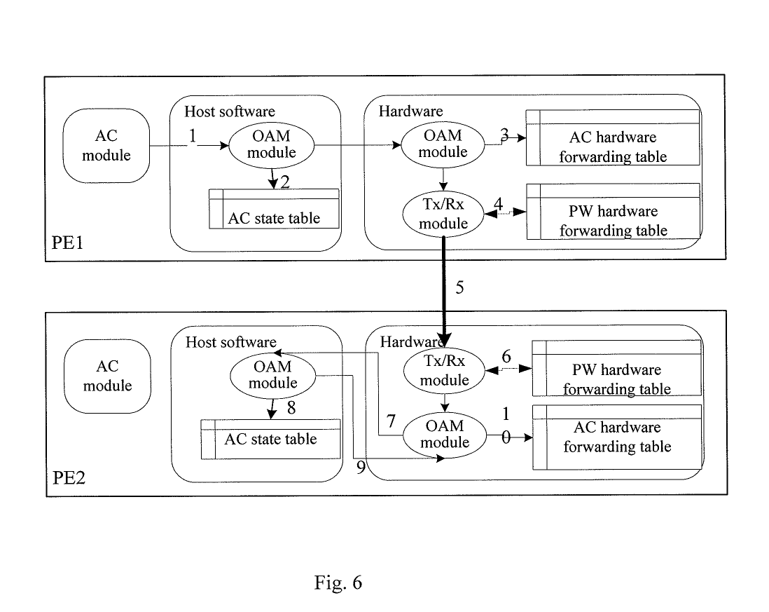

FIG. 6 is a diagram illustrating the AC state notification principle according to an embodiment of the invention. The AC state notification principle is as follows. PW is established between PE1 and PE2, and the state of the PW is UP. The host software at both sides generates PW hardware forwarding table entries, which are delivered to the hardware. AC-OAM notification is configured at both PE1 and PE2 so that both PE1 and PE2 have the capability of processing AC-OAM.

(1) When an AC state changes, the AC module notifies the host software of it.

(2) PE1 host software OAM module updates the AC state table, that is, updates the local AC state.

(3) PE1 hardware OAM module updates AC_Avail_Flag in the AC hardware forwarding table.

(4) PE1 hardware looks up the PW hardware forwarding table and assembles an AC-OAM packet.

(5) The AC-OAM packet is transmitted.

(6) PE2 receives the packet, looks up the PW hardware forwarding table, parses the packet and handles it to the hardware OAM module for processing.

(7) PE2 hardware OAM module analyzes the packet, obtains parameters of the packet, and handles it to the software OAM module for processing.

(8) PE2 host software OAM module updates the AC state table according to the sub-AC state in the packet, that is, updates the peer AC state.

(9) PE2 host software OAM module instructs the hardware OAM module to update the AC_Avail_Flag in the AC hardware forwarding table.

With such a notification mechanism, a PE may deterministically know the local AC state and the peer AC state in a service flow. Accordingly, it facilitates acquisition of precise information about the emulated service pair and rejection of the PW UP caused by sub-AC UPs not belonging to the same emulation service pair. In this way, the PW state is strictly consistent with the actual forwarding state, and service transmissions unable to find ultimate connectivity will no longer waste the processing resources of the nodes along the way and the valuable network bandwidth resources.

2. The transmission process

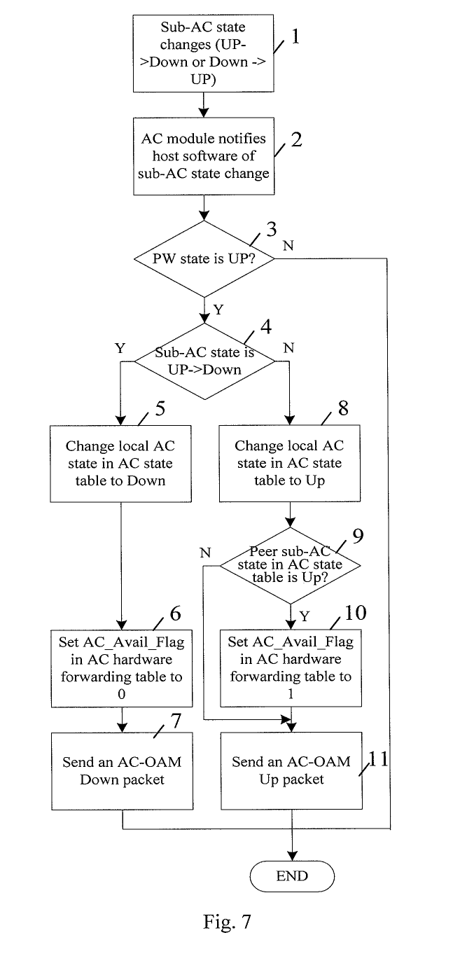

As shown in FIG. 7, the flow of the transmission process is as follows.

(1) A sub-AC state changes, for example, changes from Up to Down (denoted as UP->Down) or changes from Down to Up (denoted as Down->UP).

(2) The AC module notifies the host software of the fact that the sub-AC state changes.

(3)˜(4) If the PW state is Up, the host software determines whether the sub-AC state is UP->Down or Down->UP.

If the sub-AC state is UP->Down, steps (5)˜(7) are performed. Here, the local AC state in the AC state table is changed to Down, AC_Avail_Flag in the AC hardware forwarding table is set to abnormal or unavailable state, for example, set to 0, and an AC-OAM Down packet is sent.

If the sub-AC state is Down->UP, steps (8)˜(11) are performed. Here, the local AC state in the AC state table is changed to Up and the peer AC state in the AC state table is also Up. AC_Avail_Flag in the AC hardware forwarding table is set to be normal or available state, for example, set to 1, and an AC-OAM Up packet is sent.

3. The reception process

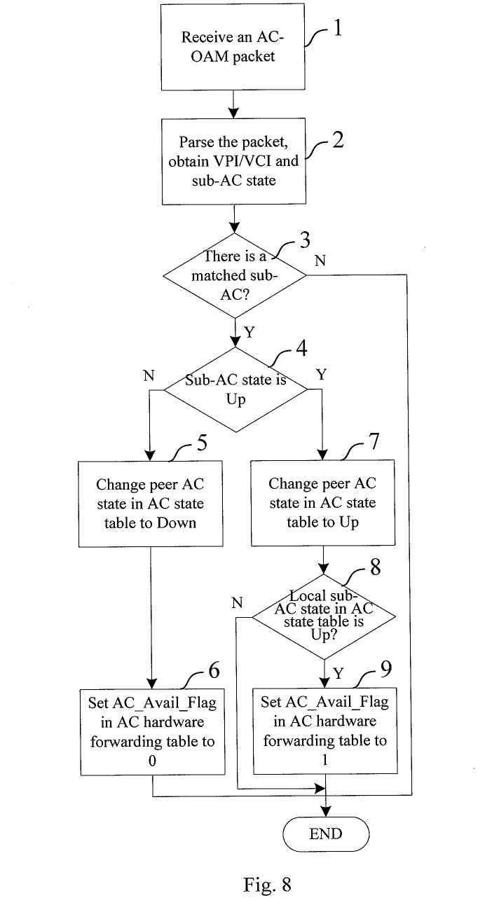

As shown in FIG. 8, the flow of the reception process is as follows:

(1) A PE receives an AC-OAM packet.

(2) The packet is parsed, to obtain VPI/VCI and sub-AC state.

(3) A determination is made as to whether there is a matched sub-AC. If the determination is negative, the flow ends. If the determination is positive, the flow proceeds to step (4).

(4) A determination is made as to whether the sub-AC state is Up or Down.

If the sub-AC state is Down, steps (5) and (6) are performed. The peer AC state in the AC state table is changed to Down and AC_Avail_Flag in the AC hardware forwarding table is set to abnormal or unavailable state, for example, set to 0.

If the sub-AC state is Up, steps (7) to (9) are performed. The peer AC state in the AC state table is changed to Up and a determination is made as to whether the local sub-AC state is Up. If yes, AC_Avail_Flag in the AC hardware forwarding table is set to normal or available state, for example, set to 1. Otherwise, the flow ends.

V. The Generality of the AC State Notification

The AC state notification mechanism based on AC-OAM is not limited to the N to 1 mode of ATM PWE3. It is equally applicable to other PWE3 services, such as Eth/TDM/FR. In ATM PWE3, VPI/VCI may be used to identify a specific pair of services. Similarly, VLAN ID in Eth PWE3 may be used to identify a specific pair of services. VPI/VCI in the AC-OAM packet and the AC hardware forwarding table are replaced with a corresponding service identifier, for example, Eth VLAN ID. In this way, the AC state notification based on OAM packets may be used on the PW service emulation links.

A more universal approach is to identify a specific pair of services by using general sub-AC identifiers. That is, AC-ID is used to represent VPI/VCI in ATM, VLAN ID in Eth and so on, and a mapping relationship is established between the AC-ID and the specific pair of services. In this way, the AC hardware forwarding table has a format shown in Table 8.

TABLE 8

| AC-ID | PW Label | . . . | AC _Avail_Flag |
|---|---|---|---|
| | | . . . | |
| | | . . . | |

In this manner, only one AC hardware forwarding table may be maintained. The relationship between AC and PW is more straightforward. The service configuration commands for bonding AC and PW are simpler, and the configuration amount reduces by a half. The hardware implementation is relatively simpler. Information about a specific PVC may be determined by linearly looking up the index corresponding to the AC-ID, so that the forwarding speed may be improved.

As shown in FIG. 6, the invention also provides a PE based on the AC connection state notification method in a packet switching network, including an AC circuit module, a transmitting/receiving module and an OAM module coupled to the AC circuit module and the transmitting/receiving module. The AC circuit module is configured to notify the OAM module of a change in the sub-AC state. The OAM module is configured to operate the transmitting/receiving module to transmit an OAM packet carrying fields for sub-AC identifications and sub-AC states to notify the peer.

The PE further includes a sub-AC hardware forwarding table module coupled to the OAM module. The correspondence among the sub-AC ID, the state and PW is established in the sub-AC hardware forwarding table module. The normal state for the sub-AC is valid when the sub-AC states at both sides are normal. The sub-AC is in abnormal state when the local sub-AC state or the peer sub-AC state is abnormal. In traffic forwarding, the OAM module refers the sub-AC hardware forwarding table module for an associated sub-AC state. When the sub-AC is normal, the transmitting/receiving module performs forwarding with the associated PW. The forwarding is performed by looking up the PW hardware forwarding table.

The PE further includes a sub-AC state table module coupled to the OAM module, configured to record the local sub-AC state and the peer sub-AC state, so as to reflect the availability of the sub-AC.

The above two methods for determining PW connection state and for notifying AC connection state and the associated PEs may be employed separately or in combination.

The invention has been described with reference to specific embodiments, but various modifications are possible to accommodate particular requirements when the invention is practiced. Accordingly, it is to be understood that the specific embodiments are just illustrative, instead of limiting the scope of the invention.

1. A method for determining PW connection state in a packet switching network, the packet switching network being provided with PW-OAM packets for detection of connection state of a PW, the method comprising:
transmitting, by a first PE, a PW-OAM request packet over a PW link between the first PE and a second PE;
detecting, by the first PE, whether the PW-OAM reply packet is received within a preset time period;
determining, by the first PE, that the PW between the first PE and the second PE is normal when the PW-OAM reply packet is received within a preset time period.

2. The method for determining PW connection state in a packet switching network according to claim 1, further comprising:
notifying the second PE via an AC-OAM packet when the sub-AC state of the first PE changes, the AC-OAM packet carrying fields for sub-AC identifications and sub-AC states.

3. The method for determining PW connection state in a packet switching network according to claim 1, wherein a PW availability flag is set in a PW hardware forwarding table to constrain the forwarding of a data packet, the PW availability flag being controlled based on the detection result, and
the data packet is forwarded normally when the PW availability flag is set to indicate that the PW is available; and
the data packet is not forwarded when the PW availability flag is set to indicate that the PW is unavailable.

4. The method for determining PW connection state in a packet switching network according to claim 3, wherein three layers of labels are contained in the PW-OAM request packet, the outer layer being a LSP label, the middle layer being a PW label, the inner layer being an OAM label, the LSP label being used for POP operation and the PW label being used for SWAP operation.

5. The method for determining PW connection state in a packet switching network according to claim 4,
wherein upon receipt of the OAM request packet, the second PE responds with the OAM reply packet by:
performing a POP operation on the outer-layer LSP label, and looking up the ILM table with the PW label;
determining whether the PW is configured with OAM function according to an OAM flag added to an ILM table, the OAM flag indicating whether an associated PW is configured with OAM function,
processing all the forwarding normally if the PW is not configured with OAM function,
determining the next layer of label if the PW is configured with OAM function;
if the next layer of label exists and is a stack-bottom label with a value equal to 14 to indicate that the captured packet is a PW-OAM packet, performing a SWAP operation on the PW-OAM packet, so as to obtain new LSP and PW labels, and
reassembling the PW-OAM packet and sending the reassembled PW-OAM packet back to the first PE.

6. The method for determining PW connection state in a packet switching network according to claim 5, wherein the second PE performs the SWAP operation on the PW label by:
establishing a SWAP table entry for the inner-layer label and delivering the SWAP table entry to hardware; and
performing a SWAP operation with the table entry after capturing the PW OAM packet.

7. A PE for use with the method according to claim 1 in a packet switching network, the packet switching network being provided with PW-OAM packets for detection of connection state of a PW, the PE comprising:
a transmitting module;
a receiving module; and
an OAM module coupled to the transmitting module and the receiving module, configured to operate the transmitting module to transmit a PW-OAM packet;
wherein a packet is received by the receiving module and delivered to the OAM module for processing, if the OAM module determines that the received packet is a PW-OAM reply packet of the PW-OAM request packet that is received within a preset time period, the PW between the PEs is determined to be normal.

8. A PE for use with the method according to claim 1 in a packet switching network, the packet switching network being provided with PW-OAM packets for detection of connection state of a PW, the PE comprising:
a transmitting module;
a receiving module; and
an OAM module coupled to the transmitting module,
wherein a PW-OAM packet is received by the receiving module and delivered to the OAM module for processing, and
the OAM module is configured to operate the transmitting module to return the PW-OAM packet to the transmitting side.

9. A method for notification of AC connection state in a packet switching network, comprising:
determining, by a first PE, whether a sub-AC state of the first PE changes;
transmitting by the first PE an AC-OAM packet to a second PE when the sub-AC state of the first PE changes, the AC-OAM packet carrying fields for sub-AC identifications and sub-AC states.

10. The method for notification of AC connection state in a packet switching network according to claim 9, further comprising:
forwarding services with the PW associated with the sub-AC when both a local sub-AC state and a peer sub-AC state are normal, the local sub-AC state and the peer sub-AC state being recorded at the first PE; and
not forwarding services when the local sub-AC state or the sub-AC state is abnormal;
wherein determining the sub-AC state comprises: determining the sub-AC state to be normal when both the local sub-AC state and the peer sub-AC state are normal, and determining the sub-AC state to be abnormal when the local sub-AC state or the peer sub-AC state is abnormal.

11. The method for notification of AC connection state in a packet switching network according to claim 10, wherein a mapping correspondence among sub-AC, PW and sub-AC state is established at the first PE and set in the sub-AC hardware forwarding table;
the service forwarding comprises:
obtaining an associated sub-AC state with the sub-AC,
forwarding with the associated PW when the sub-AC state is normal.

12. The method for notification of AC connection state in a packet switching network according to claim 11, wherein
the sub-AC is identified with a sub-AC identification;
the sub-AC identification is a VPI/VCI or a VLAN ID; or
the sub-AC identification is a universal ID for a pair of services, and the mapping correspondence among the universal ID and the VPI/VCI or VLAN ID is set at the first PE.

13. A PE for use with the method according to claim 9 in a packet switching network, comprising:
an AC circuit module,
a transmitting/receiving module; and
an OAM module coupled to the AC circuit module and the transmitting/receiving module;
wherein the AC circuit module is configured to notify the OAM module of a sub-AC state change, and the OAM module is configured to operate the transmitting/receiving module to transmit an OAM packet carrying fields for sub-AC identifications and sub-AC states to notify the peer PE.

14. The PE for use in a packet switching network according to claim 13, further comprising:
a sub-AC hardware forwarding table module coupled to the OAM module,
wherein the correspondence among sub-AC ID, state and PW is established in the sub-AC hardware forwarding table module, the sub-AC is in normal state when the sub-AC states at both sides are normal;
the sub-AC is in abnormal state when the local sub-AC state or the peer sub-AC state is abnormal;
the OAM module is configured to refer to the sub-AC hardware forwarding table module for an associated sub-AC state when forwarding services, and
the transmitting/receiving module is configured to perform service forwarding with the PW when the sub-AC is in normal state.

15. The PE for use in a packet switching network according to claim 14, further comprising:
a sub-AC state table module coupled to the OAM module, configured to record the local sub-AC state and the peer sub-AC state, so as to reflect the availability of the sub-AC.
